(19) United States
(12) Patent Application Publication
(10) Pub. No.: US 2020/0314674 A1
(43) Pub. Date: Oct. 1, 2020

(54) Early Measurement Reporting for Configuration of Carrier Aggregation or Dual Connectivity

(71) Applicant: Apple Inc., Cupertino, CA (US)

(72) Inventors: Fangli Xu, Beijing (CN); Longda Xing, San Jose, CA (US); Srinivasan Nimmala, San Jose, CA (US); Sree Ram Kodali, Sunnyvale, CA (US); Dawei Zhang, Saratoga, CA (US); Haijing Hu, Beijing (CN); Yuqin Chen, Shenzhen (CN); Srirang A. Lovlekar, Cupertino, CA (US); Murtaza A. Shikari, Mountain View, CA (US); Sethuraman Gurumoorthy, San Jose, CA (US)

(21) Appl. No.: 16/821,351

(22) Filed: Mar. 17, 2020

(30) Foreign Application Priority Data
Mar. 28, 2019 (CN) 201910241545.4

(51) Int. Cl. H04W 24/10; H04W 76/30; H04W 76/19; H04W 80/08

(52) U.S. Cl. CPC H04W 24/10; H04W 80/08; H04W 76/19; H04W 76/30

(57) ABSTRACT

A user equipment (UE) device may make measurements of network-configured frequencies in an idle mode or an inactive mode, and report the measurements to the network during (or after) a connection establishment or a connection resume process. The initiation of measurements may be delayed until a connection is imminent or until an upper layer request. A result timer may be used to ensure that reported measurements are not too old to be of use. A configuration timer may be used to selectively report inter-frequency/RAT cell measurements. The configuration timer may also be used repeatedly in conjunction with intervening backoff periods. A base station of the network may use the measurements to make informed decisions on when and how to configure carrier aggregation or dual connectivity for the UE device.

### PRIORITY CLAIM

This application claims the benefit of priority to Chinese Patent Application No. 201910241545.4, filed on Mar. 28, 2019, titled “Early Measurement Reporting for Configuration of Carrier Aggregation or Dual Connectivity”, which is hereby incorporated by reference in its entirety as though fully and completely set forth herein.

### FIELD

The present application relates to wireless devices, and more particularly, relates to mechanisms for a wireless device to enable the configuration of carrier aggregation and/or dual connectivity with low latency and/or low power consumption.

### DESCRIPTION OF THE RELATED ART

Wireless communication systems are rapidly growing in usage. Further, wireless communication technology has evolved from voice-only communications to also include the transmission of data, such as Internet and multimedia content. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), 5G NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

Carrier Aggregation (CA) and Dual Connectivity (DC) are mechanisms for increasing the bandwidth of communication with wireless devices. However, in order to perform CA or DC in an effective manner, the network may require information regarding the condition of signals on available frequencies in the neighborhood of a wireless device. Thus, there exists a need for improved mechanisms for providing such information to the network.

### SUMMARY

Embodiments relate to apparatuses, systems, and methods to enable a user equipment (UE) device to perform measurements (e.g., idle mode or inactive mode measurements) on configured frequencies, and to report such measurements to the network with low-latency and/or without excessive power consumption. The network may use the report to make informed decisions on when and how to assign frequencies to the UE for carrier aggregation or dual connectivity.

In one set of embodiments, a method for operating a user equipment (UE) device may include the following operations.

The UE may receive a downlink message (e.g., a Radio Resource Control message) indicating a first set of one or more frequencies to be measured.

The UE may perform a measurement process, wherein the measurement process is initiated during an operational mode, wherein the operational mode is an idle mode or an inactive mode of the UE device, wherein the measurement process includes performing measurements to obtain measurement data for each frequency in the first set of the one or more frequencies.

The UE may transmit a measurement report based on at least a portion of the measurement data for at least one of the frequencies in said first set of one or more frequencies. The measurement report may be transmitted while connecting to the network or after having connected.

In one set of embodiments, a method for operating a user equipment (UE) device may include the following operations.

The UE may start a measurement process and a measurement configuration timer in response to receiving a downlink message indicating a set of one or more frequencies to be measured, wherein the measurement process obtains measurement data for each of the more or frequencies of said set.

The UE may determine that the set of one or more frequencies includes at least one frequency corresponding to an inter-frequency or inter-RAT cell.

In response to expiry of the measurement configuration timer, the UE may transmit a measurement report based on at least a portion of the measurement data corresponding to said at least one frequency, wherein said transmitting is performed as part of a connection establishment process.

In one set of embodiments, a method for operating a user equipment (UE) device may include the following operations.

The UE may start a measurement process and a measurement configuration timer in response to receiving a downlink message indicating a set of one or more frequencies to be measured, wherein the measurement process obtains measurement data for each of the more or frequencies of said set.

In response to expiry of the measurement configuration timer, the UE may perform up to N iterations of a set of operations including: (a) stopping the measurement process for a backoff time period; and (b) restarting the measurement process and the measurement configuration timer, wherein said performance of up to N iterations terminates in response to the UE device determining that a connection process is to be performed, wherein N is a positive integer or infinity.

The UE may perform the connection process, wherein an indication of measurement availability is transmitted as part of the connection process.

In one set of embodiments, a method for operating a user equipment (UE) device may include the following operations.

During an operational mode of the UE, the UE may perform a measurement process to obtain a measurement on a first frequency.

The UE may store the measurement on the first frequency in memory, and recording a first measurement time of the measurement on the first frequency.

After having transmitted a first measurement report including the measurement on the first frequency, the UE may receiving a subsequent connection release message that includes an indication of a set of one or more frequencies to be measured.

The UE may connect to a wireless network.

In response to determining that (a) the first frequency is included in the set of one or more frequencies and (b) a difference between an anticipated transmission time and the first time is less or equal to a measurement timer value, the UE may transmit a second measurement report at the anticipated transmission time, wherein the second measurement report includes the stored measurement.

In one set of embodiments, a method for operating a user equipment (UE) device may include the following operations.

The UE may perform measurements on a first frequency identified in a downlink message, and recording a time of each of the measurements.

In response to a determination that a connection process is to be performed, the UE may determine whether a difference between an anticipated time of transmission of a measurement report and the time of a most recent measurement on the first frequency is less than a measurement result timer value, wherein the connection process is a connection establishment process or a connection resume process.

In response to the difference being less than the measurement result timer value, the UE may transmit a measurement report at the anticipated time, wherein the measurement report includes the most recent measurement on the first frequency.

In any of the various embodiments described herein, it is understood that the network may receive a measurement report (via a base station of the network), and use that measurement report to determine a configuration of carrier aggregation or dual connectivity for the UE. The network may then transmit one or more messages to the UE defining the configuration so that the UE may perform CA or DC.

With respect to dual connectivity, the UE may be configured to concurrently (or substantially concurrently) connect with multiple nodes of the same generation (e.g., 5G NR network nodes) of cellular communication technology, or of different generations (e.g., 5G NR and LTE) of cellular communication technology, among various possibilities. (5G NR is an acronym for 5^{th} Generation New Radio.)

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an example wireless communication system, according to some embodiments.

FIG. 2 illustrates a base station (BS) in communication with a user equipment (UE) device, according to some embodiments.

FIG. 3 illustrates an example block diagram of a UE, according to some embodiments.

FIG. 4 illustrates an example block diagram of a BS, according to some embodiments.

FIG. 5 illustrates an example block diagram of cellular communication circuitry, according to some embodiments.

FIG. 6A illustrates an example of connections between an EPC network, an LTE base station (eNB), and a 5G NR base station (gNB), according to some embodiments.

FIG. 6B illustrates an example of a protocol stack for an eNB and a gNB, according to some embodiments.

FIG. 7 illustrates one embodiment of a method for performing idle mode measurement of configured frequencies.

FIG. 8 illustrates an embodiment where the initiation of measurements is delayed until a connection process has started or is about to start.

FIG. 9 illustrates an embodiment where the initiation of measurements is delayed until an upper layer request for access.

FIG. 10 illustrates an embodiment where a UE may receive measurement configuration from a first node, and then connect and report to a second node.

FIG. 11 illustrates an embodiment where a measurement configuration timer is stopped for a backoff period after having expired, and then allowed to restart.

FIG. 12 illustrates an embodiment where a measurement result timer is used to ensure an age constraint (i.e., a newness constraint) on measurements to be reported to the network.

FIG. 13 illustrates an embodiment where the measurement result timer is used in conjunction with a measurement configuration timer.

FIG. 14 illustrates an embodiment where a UE device transmits measurement report based on measurements initiated during an operation mode (e.g., an idle mode or an inactive mode) of the UE.

FIG. 15 illustrates an embodiment where a measurement configuration timer is used in connection with reporting measurement(s) on an inter-frequency or inter RAT cell.

FIG. 16 illustrates an embodiment where multiple iterations of backoff and timer restart may be performed.

FIG. 17 illustrates an embodiment where a previously reported measurement for a frequency, corresponding to a previous measurement configuration, may be transmitted in a subsequent measurement report, provided it satisfies an age constraint and conforms to a current measurement configuration.

FIG. 18 illustrates an embodiment where the UE employs a measurement result timer to impose an age constraint on reported measurements.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

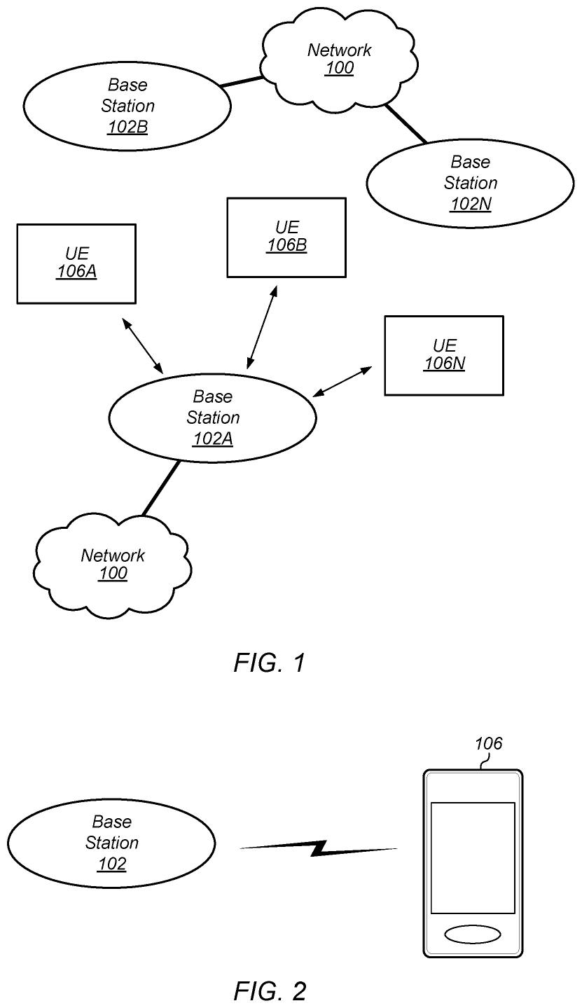

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs. As another possibility, base station 102A may be a LTE base station, or “eNB”. In some embodiments, an eNB may be connected to a legacy evolved packet core (EPC) network and/or to a NR core (NRC) network.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

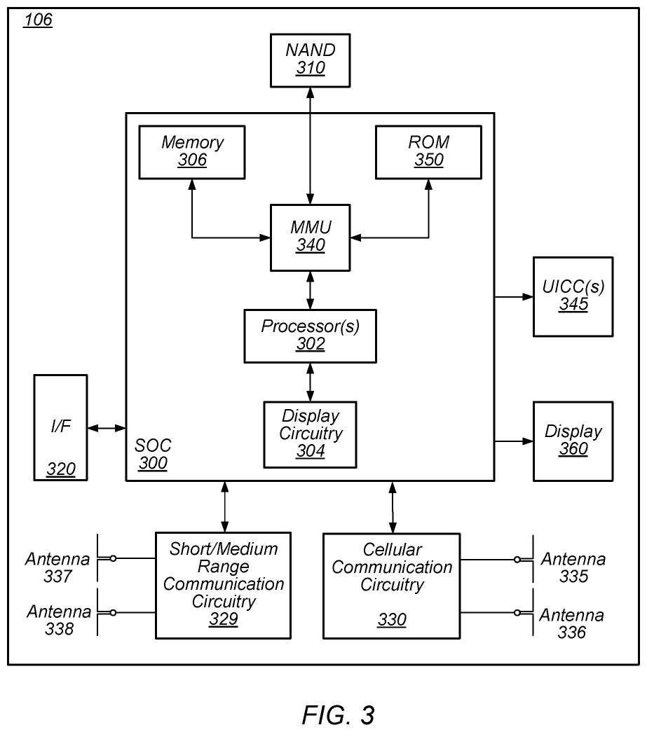

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT and transmit an indication that the wireless device is capable of maintaining substantially concurrent connections with the first network node and a second network node that operates according to the second RAT (or that also operates according to the first RAT). The wireless device may also be configured to transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing features for reporting idle mode or inactive mode measurements, as well as the various other techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 335, 336, 337, 338, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

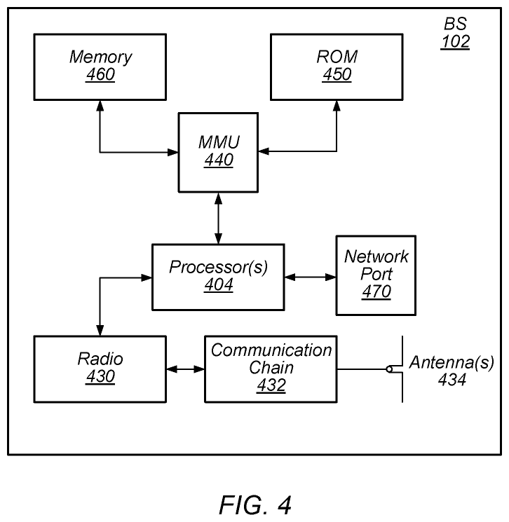

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain, or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

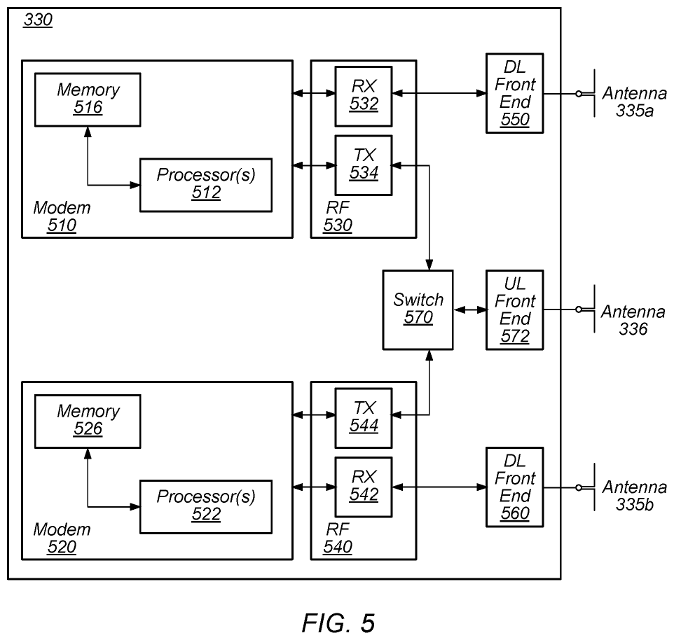

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, are also possible. According to some embodiments, cellular communication circuitry 330 may be included in a communication device, such as communication device 106 described above herein. As noted above herein, communication device 106 may be a user equipment (UE) device, a mobile device or mobile station, a wireless device or wireless station, a desktop computer or computing device, a mobile computing device (e.g., a laptop, notebook, or portable computing device), a wearable device, a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to, e.g., communicatively; directly or indirectly), dedicated processors, and/or radios for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, such as LTE or LTE-A, and modem 520 may be configured for communications according to a second RAT, such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 330 may be configured to transmit, via the first modem while the switch is in the first state, a request to attach to a first network node operating according to the first RAT and transmit, via the first modem while the switch is in a first state, an indication that the wireless device is capable of maintaining substantially concurrent connections with the first network node and a second network node that operates according to the second RAT. The wireless device may also be configured transmit, via the second radio while the switch is in a second state, a request to attach to the second network node. The request may include an indication that the wireless device is capable of maintaining substantially concurrent connections with the first and second network nodes. Further, the wireless device may be configured to receive, via the first radio, an indication that dual connectivity with the first and second network nodes has been established.

As described herein, the modem 510 may include hardware and software components for implementing features for performing any of the various embodiments described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing features for performing any of the various embodiments described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

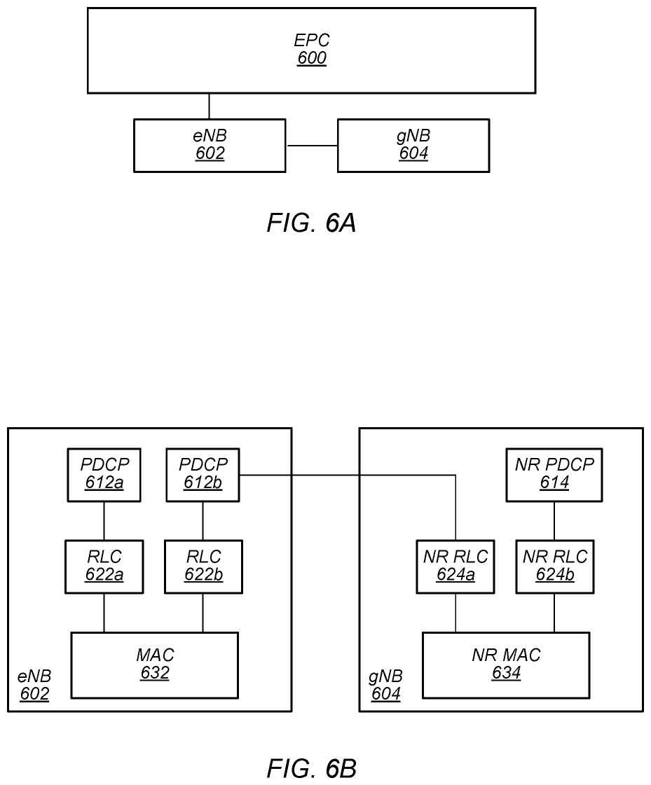

### FIGS. 6A-6B: 5G NR Non-Standalone (NSA) Architecture with LTE

In some implementations, fifth generation (5G) wireless communication will initially be deployed concurrently with current wireless communication standards (e.g., LTE). For example, dual connectivity between LTE and 5G new radio (5G NR or NR) has been specified as part of the initial deployment of NR. Thus, as illustrated in FIGS. 6A-B, evolved packet core (EPC) network 600 may continue to communicate with current LTE base stations (e.g., eNB 602). In addition, eNB 602 may be in communication with a 5G NR base station (e.g., gNB 604) and may pass data between the EPC network 600 and gNB 604. Thus, EPC network 600 may be used (or reused) and gNB 604 may serve as extra capacity for UEs, e.g., for providing increased downlink throughput to UEs. In other words, LTE may be used for control plane signaling and NR may be used for user plane signaling. Thus, LTE may be used to establish connections to the network and NR may be used for data services.

FIG. 6B illustrates a proposed protocol stack for eNB 602 and gNB 604, according to one set of embodiments. As shown, eNB 602 may include a medium access control (MAC) layer 632 that interfaces with radio link control (RLC) layers 622a-b. RLC layer 622a may also interface with packet data convergence protocol (PDCP) layer 612a; and RLC layer 622b may interface with PDCP layer 612b. Similar to dual connectivity as specified in LTE-Advanced Release 12, PDCP layer 612a may interface via a master cell group (MCG) bearer to EPC network 600 whereas PDCP layer 612b may interface via a split bearer with EPC network 600.

Additionally, as shown, gNB 604 may include a MAC layer 634 (denoted NR MAC) that interfaces with RLC layers 624a-b. RLC layer 624a may interface with PDCP layer 612b of eNB 602 via an X2 interface for information exchange and/or coordination (e.g., scheduling of a UE) between eNB 602 and gNB 604. In addition, RLC layer 624b may interface with PDCP layer 614. Similar to dual connectivity as specified in LTE-Advanced Release 12, PDCP layer 614 may interface with EPC network 600 via a secondary cell group (SCG) bearer. Thus, eNB 602 may be considered a master node (e.g., an MeNB) while gNB 604 may be considered a secondary node (e.g., an SgNB). In some scenarios, a UE may be required to maintain a connection to both an MeNB and a SgNB. In such scenarios, the MeNB may be used to maintain a radio resource control (RRC) connection to an EPC while the SgNB may be used for capacity (e.g., additional downlink and/or uplink throughput).

Thus, FIGS. 6A-6B may represent aspects of one possible cellular communication system that implements dual connectivity. However, it should be noted that numerous other dual (or more generally, multiple) connectivity configurations are also possible, and that features of this disclosure can be implemented any of a variety of such configurations. Some other examples could include a configuration in which a gNB can be configured as a master node and an eNB can be configured as a secondary node, or a configuration in which both a master node and a secondary node operate according to the same RAT (e.g., both operate according to NR, or both operate according to LTE, etc.), among various other possible configurations.

### Early Measurement Reporting for Configuration of Carrier Aggregation or Dual Connectivity

In one set of embodiments, a UE may perform early measurement on potential secondary cells (SCells).

In some embodiments, the UE may start measurement when (or in response to) receiving an idle measurement configuration from the base station. (An idle measurement configuration is a configuration for making measurements during an idle mode.)

In some embodiments, the UE may start measurement when the UE has determined that it should enter (or alternatively, is entering) connected mode. In one embodiment, the UE may perform measurement during an initial access procedure. In another embodiment, the UE may delay the initial access procedure, and perform measurement before initiating the initial access procedure. The UE may start the initial access procedure in response to receiving the measurement results or in response to expiry of a maximum delay timer.

In some embodiments, the UE supports measurement for inter-RAT mobility. For example, if the UE is configured (e.g., in a connection release message) with a measurement configuration indicating NR/LTE measurement, the UE may retain the measurement configuration and measurement(s) made under the measurement configuration even if it reselects from the NR cell to the LTE cell.

In some embodiments, the UE may utilize a measurement configuration timer to control the lifetime of an idle/inactive measurement configuration.

In one embodiment, the UE may start the measurement configuration timer upon receiving the idle mode measurement configuration or the measurement frequency/cell configuration.

In one embodiment, the UE may restart the measurement configuration timer in response to receiving a new idle mode measurement configuration from the system information block (SIB), or after expiry of a backoff timer.

In one embodiment, the UE may stop measurement upon expiry of the measurement configuration timer.

In some embodiments, the UE may manage stored measurement results as follows.

In one embodiment, the UE may utilize a measurement result timer to control the storage lifetime of idle/inactive measurement result(s).

In one embodiment, the UE may start the measurement result timer for each frequency upon storing the corresponding measurement result, and clear the measurement result upon expiry of the measurement result timer.

In one embodiment, the UE may clear a stored measurement result if the corresponding frequency is not the frequency of a potential SCell when the UE changes the camped cell to another frequency.

In one embodiment, the UE may clear a stored measurement result if the camped cell is not within the area for the configured idle measurement.

In one set of embodiments, a UE may perform early measurement on potential secondary cells (SCells).

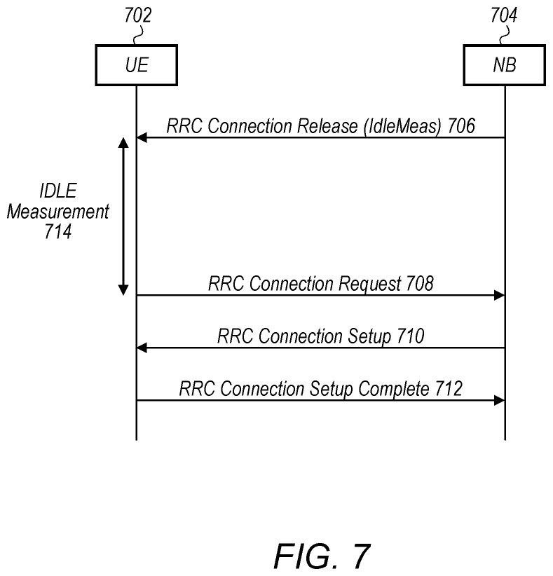

In some embodiments, a UE 702 may start measurement in response to receiving an idle measurement configuration (IdleMeas), e.g., as part of an RRC connection release message 706 as shown in FIG. 7. The result(s) of the idle measurement 714 may be reported to the NB 704 as part of a connection establishment process, e.g., in a setup complete message of that process. (The term “NB” is generic term covering within its scope of meaning both the eNB of 4G LTE and the gNB of 5G NR. Thus, NB 704 could be either an eNB or a gNB. In some embodiments, “NB” may also be generic to pre-4G base stations.) The connection establishment process may include transmitting an RRC connection request 708, receiving an RRC connection setup message 710, and transmitting an RRC connection setup complete message 712.

In one set of embodiments, a UE may start measurement in response to a determination that it should (or will) enter a connected mode. Any of a wide variety of criteria (or combinations thereof) may be used to make this determination, e.g., criteria such as buffer capacity, paging request from network, etc. Thus, in one embodiment, the UE may start measurement in response to a determination that the amount of data stored in a buffer (e.g., a uplink data buffer for data to be transmitted in the uplink) exceeds a threshold value. In another embodiment, the UE may start measurement in response to receiving a paging message from a base station (e.g., the NB).

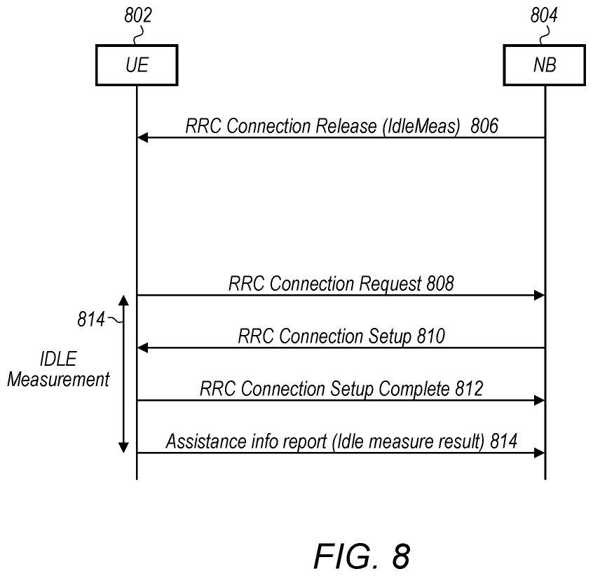

In some embodiments, a UE 802 may perform (or start) measurement during an initial access procedure, e.g., as shown in FIG. 8. (The UE 802 may enter an idle mode after receiving an RRC connection release message 806. This message 806 may include a configuration—“IdleMeas”—for idle mode measurement. Thus, the measurement 814 may be referred to as an idle measurement.) The initial access procedure may include transmitting an RRC connection request 808, receiving an RRC connection setup message 810, and transmitting an RRC connection setup complete message 812. The result(s) of the measurement, denoted “Idle measure result”, may be reported to the NB 804 in an assistance information report 814, e.g., after transmission of the RRC connection setup complete message 812. The term “assistance information” is meant to suggest information that assists the NB 804 or network in making decisions regarding the potential for carrier aggregation (CA) and/or dual connectivity (DC) relative to the UE.

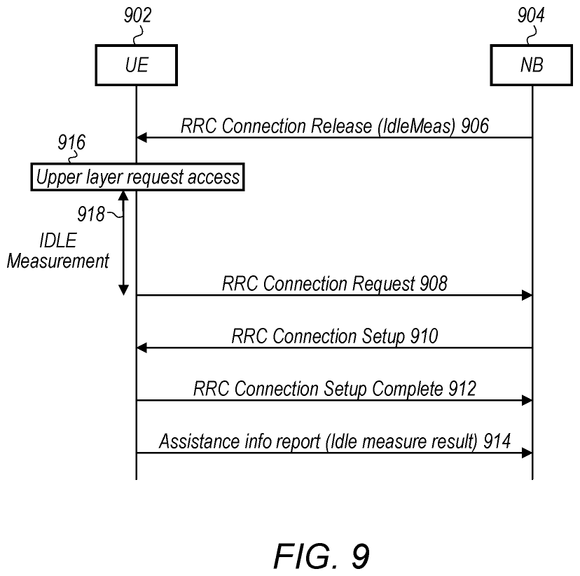

As another example, in some embodiments, a UE 902 may delay the initial access procedure, and perform measurement 918 (e.g., an idle measurement) before the initial access procedure as shown in FIG. 9. The UE 902 may enter an idle mode after receiving an RRC connection release message 906. The release message may include a configuration—“IdleMeas”—for idle mode measurement. The UE 902 may start the measurement 918 in response to an upper layer request 916 for access. The UE 902 may start the initial access procedure in response to receiving the result(s) of the measurement 918 or in response to expiry of a maximum delay timer. The initial access procedure may include transmitting an RRC connection request 908, receiving an RRC connection setup message 910, and transmitting an RRC connection setup complete message 912. The UE may transmit an assistance information report 914 including to the idle measurement result to the NB 904.

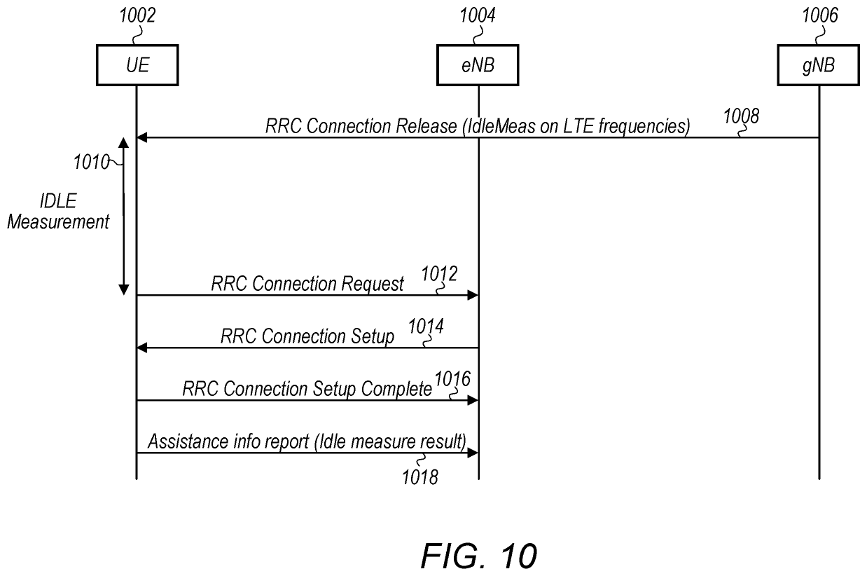

In one set of embodiments, a UE 1002 may support inter-RAT mobility as shown in FIG. 10. (RAT is an acronym for Radio Access Technology.) The UE 1002 may be configured to perform an LTE frequency measurement via an RRC release message 1008 received from gNB 1006. (Thus, the message 1008 may be referred to as an “NR RRC release message, where NR denotes “New Radio”.) The UE may perform IDLE measurement 1010 on the configured LTE frequency (or frequencies). The UE may then reselect to an LTE cell hosted by eNB 1004, and continue the configured IDLE mode measurement. The UE may report the result(s) of the idle measurement to LTE eNB 1004 if the cell supports it. For example, the UE may report the result(s) to the LTE eNB 1004 in an assistance information report 1018 after completion of a connection establishment procedure. The connection establishment procedure may include transmission of RRC connection request 1012, reception of RRC connection setup message 1014, and transmission of RRC connection setup complete message 1016.

### Measurement Configuration Timer

In one set of embodiments, a UE may employ a measurement configuration timer. For example, after expiry of the measurement configuration timer, if the UE is measuring inter-frequency or inter-RAT cells that are indicated in
“RRCConnectionRelease::measIdleConfigDedicated”
   or indicated in SIB, then the UE can set
RRCConnectionSetupComplete::IdleMeasAvailable
   to TRUE, and include those measurements in an UE information response. In this fashion, extra measurements and extra power expenditure may be avoided. In some embodiments, this procedure may be applicable to any UE with Srxlev below Sinterfrequency and SinterRAT.

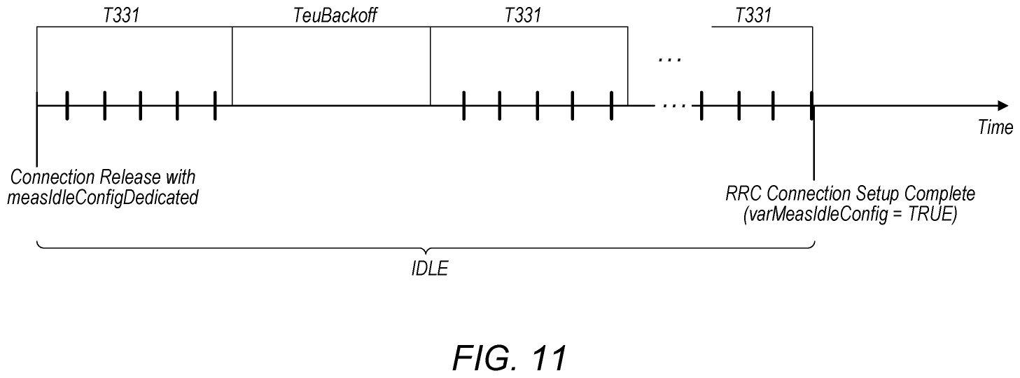

In one set of embodiments, the UE may employ a measurement configuration timer with backoff. In response to expiry of the measurement configuration timer, the UE may temporarily stop a measurement process for a period of time referred to as “backoff”, and then restart the measurement process and the timer after the backoff period. If the timer expires again, the UE may stop the measurement process again, for another backoff period. The measurement process and the timer may be started and stopped repeatedly, with a backoff period ensuing between each expiration of the timer and the next start of the timer, e.g., as shown in FIG. 11. The measurement process may involve periodically making measurements, as indicated by the series of vertical hash marks along the time axis. The periodicity of the measurement may be determined by a DRX cycle. (DRX is an acronym for Discontinuous Reception.)

In some embodiments, the network may configure the measurement configuration timer (denoted T331) with backoff period (TeuBackoff) and with an associated repetition count (Repcount). TeuBackoff is the time duration that the UE stops measuring the frequencies/cells in
“RRCConnectionRelease::measIdleConfigDedicated” or “SIB5”.

Repcount denotes the maximum number of times the timer (and the measurement) may be restarted, according to some embodiments. The measurement may terminate prior to reaching the maximum number, e.g., in response to the UE determining that it should (or will) establish or initiate connection to the network. Repcount may be an integer in a supported range
[1, MAXPossibleRepCount].
   (In one embodiment, MAXPossibleRepCount may be 2\hat{ }32. However, any of a wide variety of other values are contemplated. While the supported range starts at one, in other implementations, it may start at any other convenient value, e.g., zero.) If Repcount is equal to zero, the UE may continue to restart the timer (and the measurement) until the UE attempts connection establishment.

In some embodiments, the UE may set
“RRCConnectionSetupComplete::IdleMeasAvailable”
   to TRUE only if the timer is still running when the UE determines that a connection should (or will) be established or initiated.

In one set of embodiments, if the UE reports the result(s) of idle mode measurement to the network (NW), the UE is allowed to retain the measurement result(s) at least until receipt of an RRC Connection release. Upon receiving the RRC connection release message, the UE may determine if (a) the release message indicates that an idle mode measurement is to be performed and (b) the existing measurement result(s) correspond to a frequency or frequencies that are identified in the new measurement configuration indicated in the RRC connection release message.

If idle mode measurement is indicated, the UE will discard any measurement result for any frequency that is not included in the new measurement configuration. Alternatively, measurement results on frequencies that are included in the new measurement configuration can be reported, e.g., during the next RRC connection, as long as the measurement results are not older than a measurement configuration timer duration that was configured in the most recent RRC connection release. For example, suppose that a measurement was performed at time T1, and the UE subsequently establishes an RRC connection. Before transmitting a measurement report including the measurement, the UE may determine if a difference between an anticipated time T2 of transmission of the measurement report and the measurement time T1 is less than or equal to the measurement configuration timer duration. According to some embodiments, the measurement report may be transmitted at time T2 only if this difference condition is satisfied.

### Measurement Result Timer

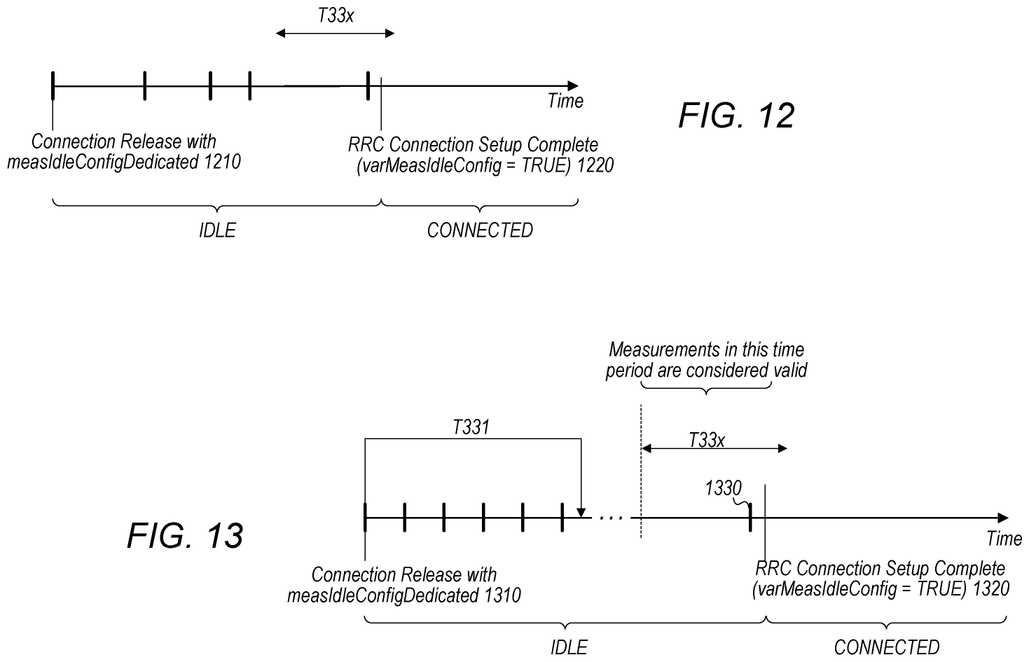

In one set of embodiments, the UE may employ a measurement result timer (denoted T33x) in order to guarantee that reported measurements are not older than the duration of the measurement result timer, e.g., as shown in FIG. 12. The network (NW) may configure the duration of the measurement result timer by sending the duration to the UE, e.g., as part of “measIdleConfigDedicated” in a connection release message 1210. The UE may then set “IdleMeasAvailable” in the RRC Connection Setup Complete message 1220 only if “varMeasIdleConfig” contains measurements that were performed no more than “T33x duration” prior to sending the RRC Connection Setup Complete message 1220.

In some embodiments, the UE may randomize the time intervals between successive measurements (indicated by thick vertical hash marks along the time axis) so that there will be a high probability that one or more of the measurements are still fresh, i.e., not older than T33x duration.

In some embodiments, the set of cells to be measured in connection with the measurement result timer (T33x) could be the same as the set configured in connection with the T331 timer.

In one set of embodiments, the UE may employ a hybrid mechanism in which the network (NW) configures both the measurement configuration timer T331 and the measurement result timer T33x, e.g., as shown in FIG. 13. For example, the NW may configure the hybrid mechanism by sending configuration information as part of “measIdleConfigDedicated” in a connection release message 1310. The configuration information may include information such as the duration of each timer and a list of frequencies (or cells) to be measured. After expiry of the measurement configuration timer T331, the UE may employ the measurement result timer T33x (as described above in connection with FIG. 12) to control the reporting of measurement(s) while establishing RRC Connection.

In some embodiments, after the measurement configuration timer T331 has expired, the UE may accumulate measurement results and their respective times of acquisition. In response to a determination that an RRC connection is to be established, the UE may determine whether there are any measurements that are less than T33x duration in age, and if there are such, the UE may transmit a signal to the network indicating the availability of such measurement(s). This signal may be transmitted as part of the next RRC connection setup complete message 1320. For example, the signal may be conveyed by setting varMeasIdleConfig=TRUE in the setup complete message 1320.

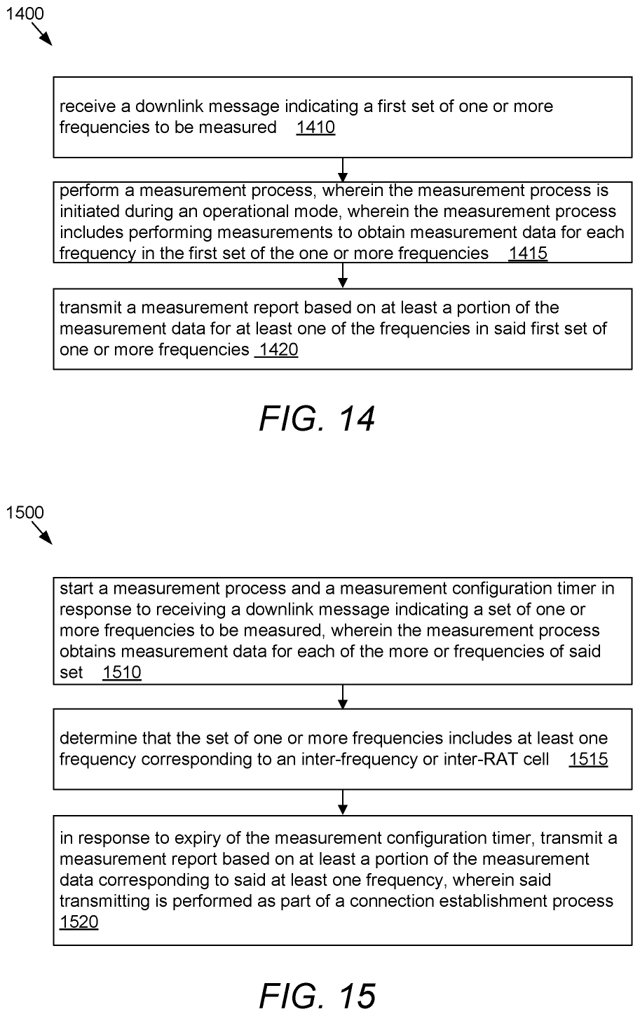

In one set of embodiments, a method 1400 for operating a user equipment (UE) device may involve the operations shown in FIG. 14, or any subset thereof (The method 1400 may also include any subset of the features, elements or embodiments described in this patent.) The method may be performed by a processing agent of the UE device. The processing agent may be realized by one or more processors executing program instructions, by one or more programmable hardware elements, by one or more dedicated hardware devices such as ASICs, or by any combination of the foregoing. In some embodiments, the method may be implemented by the UE 106 of FIG. 3 (e.g., using the SOC 300 and/or the cellular communication circuitry 330).

At 1410, the UE may receive a downlink message from a base station, where the downlink message indicates a first set of one or more frequencies (or cells) to be measured by the UE.

At 1415, the UE may perform a measurement process, wherein the measurement process is initiated during an operational mode of the UE device. The operational mode may be an idle mode or an inactive mode of the UE device. The measurement process may include performing measurements to obtain measurement data for each frequency in the first set of the one or more frequencies. In some embodiments, the measurements may include measurements of signal strength, or signal-to-noise ratio, or signal quality, or bit error rate, or packet error rate, or any combination of the foregoing.

At 1420, the UE may transmit a measurement report based on at least a portion of the measurement data for at least one of the frequencies in said first set of one or more frequencies.

In some embodiments, the downlink message is a connection release message, e.g., an RRC connection release message. (RRC is an acronym for Radio Resource Control.) The UE may enter an idle state or an inactive state after receiving the connection release message. The measurement process may be performed during the idle mode or the inactive mode.

In some embodiments, the downlink message is a system information message, e.g., an SIB transmitted by the base station.

In some embodiments, the measurement process may be initiated prior to initiation of a connection process, where the connection process is a connection establishment process or a connection resume process. (The connection establishment process is used to transition from the idle state to the connected state. The connection resume process is used to transition from the inactive state to the connected state.) The action 1420 of transmitting the measurement report may occur as part of the connection process.

In some embodiments, the measurement process may be initiated after the UE device has determined that a connection process is to be performed and before the connection process is completed. (The connection process may be a connection establishment process or a connection resume process.) The action 1420 of transmitting the measurement report may occur after the connection process is completed, e.g., as variously described above.

In some embodiments, the operational mode is the idle mode, and the measurement process may be completed prior to initiation of a connection establishment process. The action 1420 of transmitting the measurement report may occur as part of the connection establishment process.

In some embodiments, the operational mode is the idle mode, and the measurement process may be initiated after the UE device has determined that the connection establishment process is to be performed and before the connection establishment process is completed. Furthermore, the action of transmitting the measurement report may occur after the connection establishment process is completed.

In some embodiments, the measurement process may be initiated after (or in response to) an upper layer access request of the UE device. Furthermore, the action 1420 of transmitting the measurement report may occur after a connection process is completed, wherein the connection process is a connection establishment process or a connection resume process.

In some embodiments, the method 1400 may also include reselecting from a first node to a second node, e.g., as shown in FIG. 10. The downlink message mentioned above in connection with operation 1410 may be a connection release message from the first node. The measurement report may be transmitted to the second node. Furthermore, the above described connection establishment process may establish connection with the second node.

In some embodiments, the first node wirelessly communicates according to a first radio access technology, and the second node wirelessly communicates according to a second radio access technology different from the first radio access technology.

In some embodiments, the method 1400 may also include: in response to a determination that the UE is in a connected state while transmitting the measurement report, discarding the measurement data after having transmitted the measurement report.

In some embodiments, the method 1400 may also include: when the UE is in a connected state while transmitting the measurement report, discarding the measurement data after having transmitted the measurement report.

In some embodiments, the method 1400 may also include: (a) receiving a subsequent connection release message after having transmitted the measurement report; and (b) in response to a determination that the subsequent connection release message does not include configuration for idle mode measurement or inactive mode measurement, discarding the measurement data.

In one set of embodiments, a method 1500 for operating a user equipment (UE) device may include the operations shown in FIG. 15, or any subset thereof. (The method 1500 may also include any subset of the features, elements or embodiments described in this patent.) The method may be performed by a processing agent of the UE device. The processing agent may be realized by one or more processors executing program instructions, by one or more programmable hardware elements, by one or more dedicated hardware devices such as ASICs, or by any combination of the foregoing. In some embodiments, the method may be implemented by the UE 106 of FIG. 3 (e.g., using the SOC 300 and/or the cellular communication circuitry 330).

At 1510, the UE may start a measurement process and a measurement configuration timer in response to receiving a downlink message indicating a set of one or more frequencies to be measured. The measurement process may obtain measurement data for each of the more or frequencies of said set, e.g., as variously described above. (The downlink message may also include a configuration for measuring during an idle mode or an inactive mode.)

At 1515, the UE may determine that the set of one or more frequencies includes at least one frequency corresponding to an inter-frequency or inter-RAT cell. (RAT is an acronym for Radio Access Technology.)

At 1520, in response to expiry of the measurement configuration timer, the UE may transmit a measurement report based on at least a portion of the measurement data corresponding to said at least one frequency. The transmission of the measurement report may be performed as part of a connection establishment process.

In some embodiments, the downlink message is a connection release message.

In some embodiments, the downlink message is a system information message.

In some embodiments, the measurement process and the measurement configuration timer are started in response to entering an idle mode or an inactive mode.

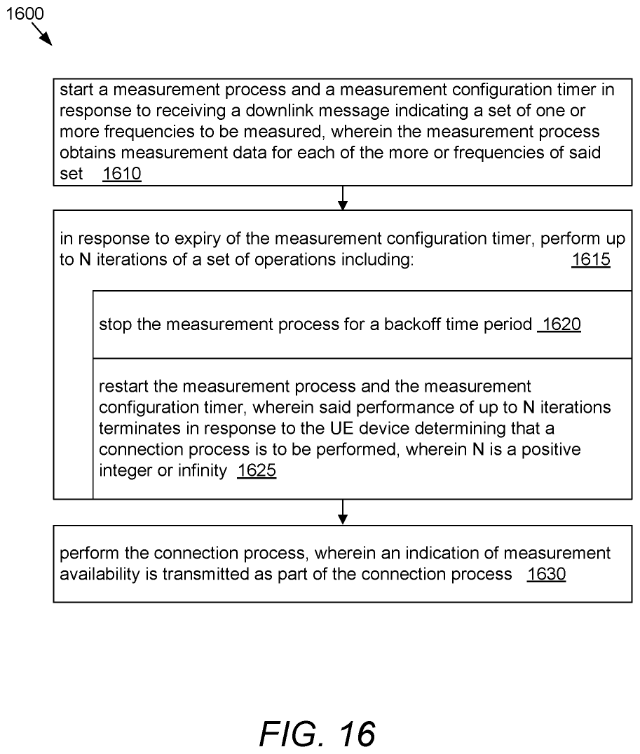

In one set of embodiments, a method 1600 for operating a user equipment (UE) device may include the operations shown in FIG. 16, or any subset thereof. (The method 1600 may also include any subset of the features, elements or embodiments described in this patent.) The method may be performed by a processing agent of the UE device. The processing agent may be realized by one or more processors executing program instructions, by one or more programmable hardware elements, by one or more dedicated hardware devices such as ASICs, or by any combination of the foregoing. In some embodiments, the method may be implemented by the UE 106 of FIG. 3 (e.g., using the SOC 300 and/or the cellular communication circuitry 330).

At 1610, the UE may start a measurement process and a measurement configuration timer in response to receiving a downlink message indicating a set of one or more frequencies to be measured, wherein the measurement process obtains measurement data for each of the more or frequencies of said set.

At 1615, in response to expiry of the measurement configuration timer, the UE may perform up to N iterations of a set of operations including operations 1620 and 1625 as described below.

At 1620, the UE may stop the measurement process for a backoff time period.

At 1625, the UE may restart the measurement process and the measurement configuration timer, wherein said performance of up to N iterations terminates in response to the UE device determining that a connection process is to be performed, wherein N is a positive integer or infinity (i.e., a symbol representing infinity). N may take any of a wide variety of values.

At 1630, the UE may perform the connection process, wherein an indication of measurement availability is transmitted as part of the connection process.

In some embodiments, a measurement report is transmitted as part of a message of the connection process. (The connection process may be a connection establishment process or a connection resume process.) The measurement report may be based on measurement data corresponding to at least one frequency in said set of one or more frequencies.

In some embodiments, the downlink message is a connection release message.

In some embodiments, the downlink message is a system information message.

In some embodiments, a duration of the backoff time period varies pseudo-randomly between successive iterations of said performing up to N iterations.

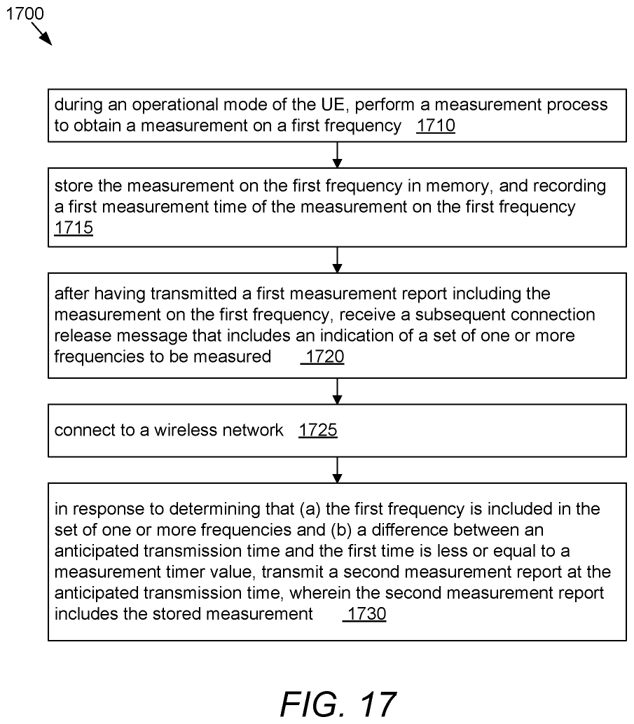

In one set of embodiments, a method 1700 for operating a user equipment (UE) device may include the operations shown in FIG. 17, or any subset thereof. (The method 1700 may also include any subset of the features, elements or embodiments described in this patent.) The method may be performed by a processing agent of the UE device. The processing agent may be realized by one or more processors executing program instructions, by one or more programmable hardware elements, by one or more dedicated hardware devices such as ASICs, or by any combination of the foregoing. In some embodiments, the method may be implemented by the UE 106 of FIG. 3 (e.g., using the SOC 300 and/or the cellular communication circuitry 330).

At 1710, during an operational mode of the UE, the UE may perform a measurement process to obtain a measurement on a first frequency. The operational mode may be an idle mode or an inactive mode.

At 1715, the UE may store the measurement on the first frequency in memory, and record a first measurement time of the measurement on the first frequency.

At 1720, after having transmitted a first measurement report including the measurement on the first frequency, the UE may receive a subsequent connection release message that includes an indication of a set of one or more frequencies to be measured.

At 1725, the UE may connect to a wireless network, e.g., as variously described above.

At 1730, in response to determining that (a) the first frequency is included in the set of one or more frequencies and (b) a difference between an anticipated transmission time and the first time is less or equal to a measurement timer value, the UE may transmit a second measurement report at the anticipated transmission time, wherein the second measurement report includes the stored measurement.

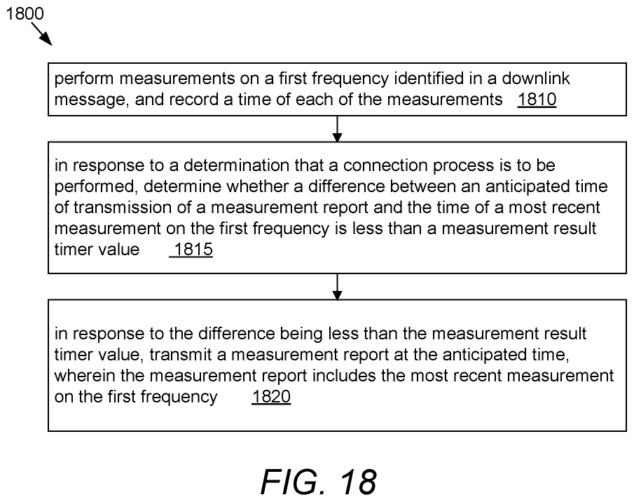

In one set of embodiments, a method 1800 for operating a user equipment (UE) device may include the operations shown in FIG. 18. (The method 1700 may also include any subset of the features, elements or embodiments described in this patent.) The method may be performed by a processing agent of the UE device. The processing agent may be realized by one or more processors executing program instructions, by one or more programmable hardware elements, by one or more dedicated hardware devices such as ASICs, or by any combination of the foregoing. In some embodiments, the method may be implemented by the UE 106 of FIG. 3 (e.g., using the SOC 300 and/or the cellular communication circuitry 330).

At 1810, the UE may perform measurements on a first frequency identified in a downlink message, and record a time of each of the measurements.

At 1815, in response to a determination that a connection process is to be performed, the UE may determine whether a difference between an anticipated time of transmission of a measurement report and the time of a most recent measurement on the first frequency is less than a measurement result timer value, wherein the connection process is a connection establishment process or a connection resume process.

At 1820, in response to the difference being less than the measurement result timer value, the UE may transmit a measurement report at the anticipated time, wherein the measurement report includes the most recent measurement on the first frequency.

In some embodiments, time duration between successive ones of the measurements is randomized.

In some embodiments, the measurement report may be transmitted as part of a message of a connection process. The connection process may be connection establishment process (when the UE is in the idle state) or a connection resume process (when the UE is in the inactive state).

In some embodiments, the measurement report may be transmitted as part of a setup complete message of a connection establishment process.

In some embodiments, the measurement report may be transmitted after a connection establishment process.

In some embodiments, the measurement report may be transmitted after a setup complete message of a connection establishment process.

In some embodiments, the downlink message is a connection release message that includes a set of one or more frequencies to be measured by the UE device. The first frequency may be included in the set of one or more frequencies.

In some embodiments, the measurement result time value may be included in the connection release message.

In some embodiments, the measurements of operation 1810 are performed during an idle mode or during an inactive mode of the UE.

In some embodiments, the method 1800 may also include: (a) performing measurements on another frequency identified in the downlink message, and recording a time of each of the measurements on the other frequency; and (b) in response to camping on a given cell that is different from an initial cell and determining that potential secondary cells of the given cell do not include the other frequency, discarding any measurements on the other frequency. The potential secondary cells/frequencies are determined based on UE CA/DC capability. (CA is an acronym for Carrier Aggregation. DC is an acronym for Dual Connectivity.)

In some embodiments, the method 1800 may also include: (a) performing measurements on a second frequency identified in the downlink message, and recording a time of each of the measurements on the second frequency, wherein the downlink message also indicates an area for measurement validity; and (b) in response to camping on a given cell that is different from an initial cell and determining that the given cell is not within the area for measurement validity, discarding any measurements on the second frequency.

In some embodiments, the measurements on the first frequency may be initiated after expiry of a measurement configuration timer that was started in response to receipt of the downlink message.

In some embodiments, an initial value of the measurement configuration timer may be indicated (or specified) in the downlink message.

In one set of embodiments, the UE may be configured to employ a measurement configuration timer in connection with idle mode or inactive mode measurement of configured frequencies, e.g., as variously described above. The inactive/idle UE may continue measurement on potential secondary frequencies even after the measurement configuration timer has expired.

In one set of embodiments, the UE may configured to employ a measurement result timer in connection with idle mode of inactive mode measurement of configured frequencies, e.g., as variously described above. The inactive/idle UE may continue measurement on potential secondary frequencies even after the measurement result time expires.

In one set of embodiments, a wireless device may establish cellular links with a first cell group (which may be configured as a master cell group MCG) and a second cell group (which may be configured as a secondary cell group SCG), e.g., to obtain dual connectivity with a cellular network. This may include attaching to and establishing a radio resource control connection with a first base station that operates according to a first RAT, which may provide a first cell (or group of cells) operating in a first system bandwidth (e.g., including a first carrier frequency). This may further include attaching to and establishing a radio resource control connection with a second base station that operates according to the second RAT (or also operates according to the first RAT), which may provide a second cell (or group of cells) operating in a second system bandwidth (e.g., including a second carrier frequency), which may possibly be different than the first system bandwidth. Note that the first base station and the second base station may be different physical base stations, or may be provided by the same physical base station and may differ only logically (e.g., a base station may be capable of providing cells according to both the first RAT and the second RAT).

In some embodiments, one of the RATs may be LTE and the other RAT may be NR; for example, the first RAT may be LTE and the second RAT may be NR, or the first RAT may be NR and the second RAT may be LTE. The order in which the cellular links are established may be arbitrary or may depend on any of various considerations, potentially including network architecture (e.g., if one of the base stations is intended for NSA operation and/or is a secondary base station), relative signal strength, relative priority level, etc. As one possibility, the wireless device may initially transmit signaling to an LTE base station, such as eNB 602 described previously herein, to establish an attachment to an LTE network. In other words, the wireless device may request a connection with the LTE base station. Similarly, in some instances, the wireless device may transmit signaling to a 5G NR base station, such as gNB 604 described previously herein, to establish an attachment to a 5G NR network. In other words, the wireless device may request a connection with the 5G NR base station.

Note that such an approach to establishing dual connectivity is one possibility among numerous other possible mechanisms and procedures for establishing dual connectivity with the MCG and the SCG. For example, as another possibility, it may also be possible that the MCG and the SCG operate according to the same RAT (e.g., both NR). Generally, the cellular links with the MCG and the SCG may be configured in accordance with any of various possible multi-RAT dual connectivity (MR-DC) configurations.

In one set of embodiments, a method for operating a user equipment (UE) device may include: starting a measurement process and a measurement configuration timer in response to receiving a downlink message indicating a set of one or more frequencies to be measured, wherein the measurement process obtains measurement data for each of the more or frequencies of said set; determining that the set of one or more frequencies includes at least one frequency corresponding to an inter-frequency or inter-RAT cell; and in response to expiry of the measurement configuration timer, transmitting a measurement report based on at least a portion of the measurement data corresponding to said at least one frequency, wherein said transmitting is performed as part of a connection establishment process.

In some embodiments, the downlink message is a connection release message. In other embodiments, the downlink message is a system information message.

In some embodiments, said measurement process and said measurement configuration timer are started in response to entering an idle mode or an inactive mode.

In one set of embodiments, a method for operating a user equipment (UE) device may include: (1) starting a measurement process and a measurement configuration timer in response to receiving a downlink message indicating a set of one or more frequencies to be measured, wherein the measurement process obtains measurement data for each of the more or frequencies of said set; in response to expiry of the measurement configuration timer, performing up to N iterations of a set of operations including: (a) stopping the measurement process for a backoff time period; and (b) restarting the measurement process and the measurement configuration timer, wherein said performance of up to N iterations terminates in response to the UE device determining that a connection process is to be performed, wherein N is a positive integer or infinity. The method may also include performing the connection process, wherein an indication of measurement availability is transmitted as part of the connection process.

In some embodiments, a measurement report is transmitted as part of a message of the connection process, wherein the connection process is a connection establishment process or a connection resume process, wherein the measurement report is based on measurement data corresponding to at least one frequency in said set of one or more frequencies.

In some embodiments, the downlink message is a connection release message. In other embodiments, the downlink message is a system information message.

In some embodiments, a duration of the backoff time period varies pseudo-randomly between successive iterations of said performing up to N iterations.

In one set of embodiments, a method for operating a user equipment (UE) device includes: during an operational mode of the UE, performing a measurement process to obtain a measurement on a first frequency, wherein the operational mode is an idle mode or an inactive mode; storing the measurement on the first frequency in memory, and recording a first measurement time of the measurement on the first frequency; after having transmitted a first measurement report including the measurement on the first frequency, receiving a subsequent connection release message that includes an indication of a set of one or more frequencies to be measured; connecting to a wireless network. The method may also include: in response to determining that (a) the first frequency is included in the set of one or more frequencies and (b) a difference between an anticipated transmission time and the first time is less or equal to a measurement timer value, transmitting a second measurement report at the anticipated transmission time, wherein the second measurement report includes the stored measurement.

In one set of embodiments, a method for operating a user equipment (UE) device may include: performing measurements on a first frequency identified in a downlink message, and recording a time of each of the measurements; in response to a determination that a connection process is to be performed, determining whether a difference between an anticipated time of transmission of a measurement report and the time of a most recent measurement on the first frequency is less than a measurement result timer value, wherein the connection process is a connection establishment process or a connection resume process; in response to the difference being less than the measurement result timer value, transmitting a measurement report at the anticipated time, wherein the measurement report includes the most recent measurement on the first frequency.

In some embodiments, a time duration between successive ones of the measurements is randomized.

In some embodiments, said measurement report is transmitted as part of a message of a connection process.

In some embodiments, the measurement report is transmitted after a connection establishment process.

In some embodiments, the downlink message is a connection release message, wherein the connection release message includes a set of one or more frequencies to be measured by the UE device, wherein the first frequency is included in the set of one or more frequencies.

In some embodiments, the measurement result time value is included in the connection release message.

In some embodiments, the measurements are performed during an idle mode or during an inactive mode.

In some embodiments, the method also includes: performing measurements on another frequency identified in the downlink message, and recording a time of each of the measurements on the other frequency; in response to camping on a given cell that is different from an initial cell and determining that potential secondary cells of the given cell do not include the other frequency, discarding any measurements on the second frequency.

In some embodiments, the method may also include: performing measurements on a second frequency identified in the downlink message, and recording a time of each of the measurements on the second frequency, wherein the downlink message also indicates an area for measurement validity; in response to camping on a given cell that is different from an initial cell and determining that the given cell is not within the area for measurement validity, discarding any measurements on the second frequency.

In some embodiments, said measurements on the first frequency are initiated after expiry of a measurement configuration timer that was started in response to receipt of the downlink message.

In some embodiments, an initial value of the measurement configuration timer is indicated in the downlink message.

In one set of embodiments, a method for operating a base station may include transmitting a downlink message indicating a first set of one or more frequencies to be measured by a UE device. The downlink message may direct the UE to perform a measurement process, wherein the measurement process is to be initiated during an operational mode, wherein the operational mode is an idle mode or an inactive mode of the UE device. The measurement process may include performing measurements to obtain measurement data for each frequency in the first set of the one or more frequencies.

The method may also include receiving a measurement report from the UE device, wherein the measurement report is based on at least a portion of the measurement data for at least one of the frequencies in said first set of one or more frequencies.

In some embodiments, the downlink message is a connection release message or a system information message.

In some embodiments, an apparatus may include a processor configured to cause a device to perform any or all parts of the preceding examples.

Yet another exemplary embodiment may include a method, comprising: performing, by a device, any or all parts of the preceding examples.

Still another exemplary embodiment may include a wireless device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

A yet further exemplary set of embodiments may include an apparatus comprising means for performing any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In any of the method embodiments described herein, it should be understood that some of the elements of the method shown may be performed concurrently, in a different order than shown, may be substituted for by other method elements, or may be omitted. Additional elements may also be performed as desired.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as a message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operating a user equipment (UE) device, the method comprising:
receiving a downlink message indicating a first set of one or more frequencies to be measured;
performing a measurement process, wherein the measurement process is initiated during an operational mode, wherein the operational mode is an idle mode or an inactive mode of the UE device, wherein the measurement process includes performing measurements to obtain measurement data for each frequency in the first set of the one or more frequencies; and
transmitting a measurement report based on at least a portion of the measurement data for at least one of the frequencies in said first set of one or more frequencies.

2. The method of claim 1, wherein the downlink message is a connection release message.

3. The method of claim 1, wherein the downlink message is a system information message.

4. The method of claim 1, wherein the measurement process is initiated prior to initiation of a connection process, wherein the connection process is a connection establishment process or a connection resume process, wherein said transmitting the measurement report occurs as part of the connection process.

5. The method of claim 1, wherein the measurement process is initiated after the UE device has determined that a connection process is to be performed and before the connection process is completed, wherein the connection process is a connection establishment process or a connection resume process, wherein said transmitting the measurement report occurs after the connection process is completed.

6. The method of claim 1, wherein the measurement process is initiated after an upper layer access request of the UE device, wherein said transmitting the measurement report occurs after a connection process is completed, wherein the connection process is a connection establishment process or a connection resume process.

7. The method of claim 1, further comprising:
reselecting from a first node to a second node, wherein the downlink message is a connection release message from the first node, wherein the measurement report is transmitted to the second node, wherein said connection establishment process establishes connection with the second node.

8. The method of claim 7, wherein said first node wirelessly communicates according to a first radio access technology, wherein the second node wirelessly communicates according to a second radio access technology different from the first radio access technology.

9. An apparatus for operating a wireless device, the apparatus comprising:
a processor configured to cause the wireless device to:
receive a downlink message indicating a first set of one or more frequencies to be measured;
perform a measurement process, wherein the measurement process is initiated during an operational mode, wherein the operational mode is an idle mode or an inactive mode of the UE device, wherein the measurement process includes performing measurements to obtain measurement data for each frequency in the first set of the one or more frequencies; and
transmit a measurement report based on at least a portion of the measurement data for at least one of the frequencies in said first set of one or more frequencies.

10. The apparatus of claim 9, wherein the downlink message is a connection release message.

11. The apparatus of claim 9, wherein the downlink message is a system information message.

12. The apparatus of claim 9, wherein the measurement process is initiated prior to initiation of a connection process, wherein the connection process is a connection establishment process or a connection resume process, wherein said transmitting the measurement report occurs as part of the connection process.

13. The apparatus of claim 9, wherein the measurement process is initiated after the processor has determined that a connection process is to be performed and before the connection process is completed, wherein the connection process is a connection establishment process or a connection resume process, wherein said transmitting the measurement report occurs after the connection process is completed.

14. The apparatus of claim 9, wherein the measurement process is initiated after an upper layer access request, wherein said transmitting the measurement report occurs after a connection process is completed, wherein the connection process is a connection establishment process or a connection resume process.

15. The apparatus of claim 9, wherein the processor is configured to cause the wireless device to:
reselect from a first node to a second node, wherein the downlink message is a connection release message from the first node, wherein the measurement report is transmitted to the second node, wherein said connection establishment process establishes connection with the second node.

16. A user equipment (UE) device comprising:
a receiver configured to receive a downlink message indicating a first set of one or more frequencies to be measured;
a processor configured to perform a measurement process, wherein the measurement process is initiated during an operational mode, wherein the operational mode is an idle mode or an inactive mode of the UE device, wherein the measurement process includes performing measurements to obtain measurement data for each frequency in the first set of the one or more frequencies; and
a transmitter configured to transmit a measurement report based on at least a portion of the measurement data for at least one of the frequencies in said first set of one or more frequencies.

17. The UE device of claim 16, wherein the measurement process is initiated prior to initiation of a connection process, wherein the connection process is a connection establishment process or a connection resume process, wherein said transmitting the measurement report occurs as part of the connection process.

18. The UE device of claim 16, wherein the measurement process is initiated after the UE device has determined that a connection process is to be performed and before the connection process is completed, wherein the connection process is a connection establishment process or a connection resume process, wherein said transmitting the measurement report occurs after the connection process is completed.

19. The UE device of claim 16, wherein the measurement process is initiated after an upper layer access request of the UE device, wherein said transmitting the measurement report occurs after a connection process is completed, wherein the connection process is a connection establishment process or a connection resume process.

20. The UE device of claim 16, wherein the processor is configured to reselecting from a first node to a second node, wherein the downlink message is a connection release message from the first node, wherein the measurement report is transmitted to the second node, wherein said connection establishment process establishes connection with the second node.
